(19) United States
(12) Patent Application Publication
(10) Pub. No.: US 2025/0313285 A1
(43) Pub. Date: Oct. 9, 2025

(54) TRAILER DEFENSE SYSTEM

(71) Applicant: Schneider Enterprise Resources, LLC, Green Bay, WI (US)

(72) Inventors: Steven Jon Jarosinski, Green Bay, WI (US); Dale D. Brusewitz, Crivitz, WI (US); Lee M. Whipp, De Pere, WI (US); Justin E. Bauer, Hobart, WI (US); Nicholas O. Anderson, Green Bay, WI (US)

(21) Appl. No.: 18/987,913

(22) Filed: Dec. 19, 2024

Related U.S. Application Data
(60) Provisional application No. 63/575,411, filed on Apr. 5, 2024.

(51) Int. Cl. B62D 53/08; B60R 25/23; B62D 63/08

(52) U.S. Cl. CPC B62D 53/085; B62D 63/08; B60R 25/23

(57) ABSTRACT

A trailer defense system includes a trailer defense mechanism configured to couple with or be integrated within a trailer. The trailer defense mechanism includes a housing including sidewalls defining one or more slots, one or more engagement features configured to couple with a kingpin and be received within the slots such that the housing and the kingpin are slidably coupled together, and an actuator configured to operatively couple with the housing and actuate to transition the trailer defense mechanism between a locked state and an unlocked state. In the locked state, access to the kingpin is inhibited by the trailer defense mechanism such that the kingpin and a coupler of a vehicle are unable to engage with each other. In the unlocked state, access to the kingpin is permitted such that the kingpin and the coupler are not restricted by the trailer defense mechanism from engaging with each other.

### CROSS-REFERENCE TO RELATED PATENT APPLICATIONS

This application claims the benefit of U.S. Provisional Patent Application No. 63/575,411, filed Apr. 5, 2024, which is incorporated herein by reference in its entirety.

### BACKGROUND

This application generally relates to the protection against unauthorized use (e.g., theft, misuse, etc.) of a trailer. Trailers enable companies and trailer owners to transport large quantities of freight. Theft and unauthorized use can lead to financial losses, operational disruptions, and safety concerns. To address these risks, there is a need for security measures to safeguard trailers.

### SUMMARY

One embodiment relates to a trailer defense system. The trailer defense system includes a trailer defense mechanism configured to couple with or be integrated within a trailer. The trailer defense mechanism includes a housing including sidewalls spaced apart from each other, the sidewalls defining one or more slots, one or more engagement features configured to couple with a kingpin and configured to be received within the slots such that the housing and the kingpin are slidably coupled together, and an actuator configured to operatively couple with the housing and configured to actuate to transition the trailer defense mechanism between a locked state and an unlocked state. In the locked state, access to the kingpin is inhibited by the trailer defense mechanism such that the kingpin and a coupler of a vehicle are unable to engage with each other. In the unlocked state, access to the kingpin is permitted such that the kingpin and the coupler are not restricted by the trailer defense mechanism from engaging with each other.

Another embodiment relates to a method for installing a trailer defense mechanism onto a trailer including a bottom wall and a floor surface defining an interior volume. The method includes cutting the floor surface to create a cavity within the interior volume, providing the trailer defense mechanism including a base support, a kingpin, a housing, and an actuator, coupling the base support to the bottom wall within the cavity, slidably coupling the kingpin to the housing, positioning the housing and the kingpin slidably coupled therewith within the cavity such that the base support engages with the kingpin, and operatively coupling the actuator with the housing, the actuator configured to translate the housing in a first direction, thereby causing the kingpin to move in a vertical direction to transition the trailer defense mechanism between a locked state and an unlocked state.

Still another embodiment relates to a trailer defense system. The trailer defense system includes a trailer including a kingpin configured to engage with a coupler of a vehicle to facilitate coupling the vehicle to the trailer, a trailer defense mechanism configured to (i) couple with or be integrated within the trailer, and (ii) selectively actuate between a locked state and an unlocked state, and a control system configured to control actuation of the trailer defense mechanism to transition between the locked state and the unlocked state. In the locked state, access to the kingpin is inhibited by the trailer defense mechanism such that the kingpin and the coupler are unable to engage with each other. In the unlocked state, access to the kingpin is permitted such that the kingpin and the coupler are not restricted by the trailer defense mechanism from engaging with each other.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

FIG. 1 is a front, left perspective view of a vehicle including a trailer, according to an exemplary embodiment.

FIG. 2 is a left side view of the vehicle and the trailer of FIG. 1, according to an exemplary embodiment.

FIG. 3 is a block diagram of a control system for the trailer of FIG. 1, according to an exemplary embodiment.

FIG. 4 is a side view of a trailer defense mechanism of the trailer of FIG. 1 in an unlocked state, according to an exemplary embodiment.

FIG. 5 is a bottom perspective view of the trailer defense mechanism of FIG. 4 in a locked state, according to an exemplary embodiment.

FIG. 6 is a side perspective view of a trailer defense mechanism of the trailer of FIG. 1 in an unlocked state, according to an exemplary embodiment.

FIG. 7 is a side perspective view of the trailer defense mechanism of FIG. 6 in a locked state, according to an exemplary embodiment.

FIG. 8 is a top perspective view of a trailer defense mechanism of the trailer of FIG. 1 in a locked state, according to an exemplary embodiment.

FIG. 9 is a perspective view of a base support of the trailer defense mechanism of FIG. 8, according to an exemplary embodiment.

FIG. 10 is a perspective view of a housing of the trailer defense mechanism of FIG. 8 in a first position, according to an exemplary embodiment.

FIG. 11 is a perspective view of a housing of the trailer defense mechanism of FIG. 8 in a second position, according to an exemplary embodiment.

FIG. 12 is a perspective view of an actuator of the trailer defense mechanism of FIG. 8 in an interior volume of the trailer of FIG. 1, according to an exemplary embodiment.

FIG. 13 is a perspective view of the actuator and the base support of the trailer defense mechanism of FIG. 8 in the interior volume of the trailer of FIG. 1, according to an exemplary embodiment.

FIG. 14 is a perspective view of the trailer defense mechanism of FIG. 8 in an unlocked state, according to an exemplary embodiment.

FIG. 15 is a bottom view of the trailer of FIG. 1 including an opening with the kingpin extending therethrough, according to an exemplary embodiment.

FIG. 16 is a flowchart outlining the steps in a method for installing the trailer defense mechanism of FIG. 8 onto the vehicle of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a trailer defense mechanism is utilized to prevent a vehicle from connecting to and moving a trailer without authorization. In some embodiments, the trailer defense mechanism selectively prevents unauthorized access to a kingpin of a trailer. The trailer defense mechanism may be integrated into the trailer such that the trailer defense mechanism is not removable therefrom. The kingpin is configured to engage with a coupler of a vehicle to facilitate coupling the vehicle with the trailer. The trailer defense mechanism may selectively actuate between a locked state and an unlocked state. In the locked state, access to the kingpin is inhibited by the trailer defense mechanism such that the kingpin and the coupler are unable to engage with each other or are restricted from engaging with one another (e.g., such that engagement is made impossible or at least more difficult than it would be in absence of the trailer defense mechanism), thereby preventing an unauthorized vehicle from coupling with and stealing the trailer. In the unlocked state, access to the kingpin is permitted such that the kingpin and the coupler are not restricted by the trailer defense mechanism from engaging with each other, thereby permitting an authorized vehicle to couple with the trailer.

In some embodiments, the trailer defense mechanism includes an actuator configured selectively actuate the kingpin between a raised (e.g., retracted) position and a lowered (e.g., extended) position to selectively permit and inhibit access to the kingpin, respectively. In some examples, the actuator may be configured to selectively actuate a sleeve between a raised (e.g., retracted) position and a lowered (e.g., extended) position to selectively permit and inhibit access to the kingpin, respectively. The sleeve may be configured to receive at least a portion of the kingpin in the lowered position to inhibit access to the kingpin. In some examples, the trailer defense mechanism includes a bar actuatable between a raised (e.g., retracted) position and a lowered (e.g., extended) position to selectively provide a clear travel path for the vehicle to access the kingpin or block the travel path of the vehicle to inhibit access to the kingpin. In some examples, the trailer defense mechanism is configured to control one or more components of the trailer to limit one or more operations of the trailer. In such examples, the trailer defense mechanism may engage one or more brake systems of the trailer to inhibit rotation of the tire assemblies, thereby inhibiting or otherwise dissuading an unauthorized operator from stealing the trailer.

A control system may be configured to control actuation of the trailer defense mechanism to transition between the locked state and the unlocked state. An authorized user of the trailer (e.g., an owner, a supervisor, etc.) may remotely lock or unlock a trailer (e.g., in coordination with a schedule, based on access credentials, based on a request, etc.), thereby preventing the trailer from being misused or stolen. The trailer owner may manage a pool of trailers by providing an access code to an individual truck driver in real time, allowing that driver to lock or unlock the trailer. Trailers not being used may be automatically locked, over-the-air, remotely by the authorized user, in some embodiments.

### Vehicle Configuration

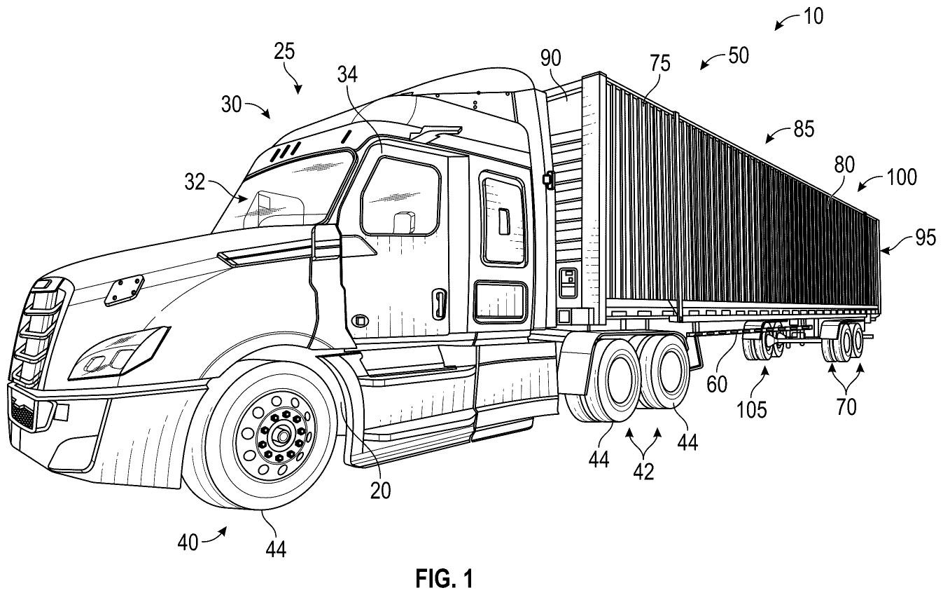

As shown in FIG. 1, a vehicle (e.g., a vehicle assembly, a truck, etc.), shown as vehicle 10, is configured as a truck (e.g., a semi-tractor or semi-truck, such as a truck configured to haul a trailer partially or fully filled with cargo). The vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. In some embodiments, the chassis 20 includes a pair of frame rails that extend along a length of the vehicle 10. In other embodiments, the chassis 20 is otherwise configured (e.g., as a single, continuous piece, etc.).

As shown in FIG. 1, a cabin or operator compartment, shown as cab 30, is coupled to a front end portion of the chassis 20. Together, the chassis 20 and the cab 30 define a front end of the vehicle 10, shown as front end 25. The cab 30 extends above the chassis 20. The cab 30 includes an enclosure or main body that defines an interior volume, shown as cab interior 32, that is sized to accommodate one or more operators. The cab 30 also includes one or more doors 34 that facilitate selective access to the cab interior 32 from outside of the vehicle 10. The cab interior 32 contains one or more components that facilitate operation of the vehicle 10 by the operator. By way of example, the cab interior 32 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 30 may facilitate operator control over the drive components of the vehicle 10 and/or over any implements of the vehicle 10.

As shown in FIG. 1, the vehicle 10 includes a series of axle assemblies or drive assemblies, shown as front axle 40 and rear axles 42. As shown, the vehicle 10 includes one front axle 40 coupled to the chassis 20 near a front end of the front end 25 of the vehicle 10 and two rear axles 42 (e.g., a tandem rear axle) coupled to the chassis 20 near a rear end of the front end 25 vehicle 10. In other embodiments, the vehicle 10 includes more or fewer axles (e.g., one rear axle 42). The front axle 40 and the rear axles 42 each include a plurality of tractive elements (e.g., wheels, treads, etc.), shown as wheel and tire assemblies 44. The wheel and tire assemblies 44 are configured to engage a support surface (e.g., roads, the ground, etc.) to support and propel the vehicle 10. The front axle 40 and the rear axle 42 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle 10.

As shown in FIG. 1, the vehicle 10 includes a rear assembly, module, implement, body, or cargo area, or application kit, shown as trailer 50, coupled to a rear end of the vehicle 10. The trailer 50 includes a chassis, shown as trailer frame 60, a plurality of axles and wheel assemblies, shown as trailer axles 70, coupled to the trailer frame 60, and a rear body or cargo container (e.g., an International Organization for Standardization (ISO) container, an intermodal (IM) container, shipping container, etc.), shown as container 75, coupled to the trailer frame 60. The container 75 may be closed or open to the environment. The container 75 is configured to store cargo (e.g., cars, equipment, etc.) during transportation. According to an exemplary embodiment, the container 75 is an ISO container or an IM container that is removable from the trailer frame 60. In other embodiments, the container 75 is fixed to the trailer frame 60.

As shown in FIG. 1, the container 75 includes opposing sidewalls, shown as left wall 80 and right wall 85. The left wall 80 and the right wall 85 are vertically oriented and are laterally offset from one another. The container 75 includes opposing end walls, shown as front wall 90 and rear wall 95. The front wall 90 and the rear wall 95 are vertically oriented and are longitudinally offset from one another. The front wall 90 and the rear wall 95 extend in a lateral direction between the left wall 80 and the right wall 85. The container 75 includes a top wall 100 and a bottom wall 105 that are horizontally oriented and are vertically offset from one another. The top wall 100 and the bottom wall 105 extend in (i) a lateral direction between the left wall 80 and the right wall 85 and (ii) a longitudinal direction between the front wall 90 and the rear wall 95. Collectively, the left wall 80, the right wall 85, the front wall 90, the rear wall 95, the top wall 100, and the bottom wall 105 define an interior volume (e.g., storage volume, cargo volume, interior chamber, etc.) of the container 75, shown as interior volume 110.

According to an exemplary embodiment, the container 75 includes a door positioned at a rear end of the container 75 that facilitates selective access to the interior volume 110 of the container 75. In some embodiments, the rear wall 95 is configured as one or more doors. In some embodiments, the door is otherwise positioned about sides of the container 75 to facilitate selective access to the interior volume 110 of the container 75. The container 75 may include a ramp to facilitate loading and unloading cargo from the vehicle 10. By way of example, the ramp may provide a surface to drive (e.g., guide, direct, load, unload, etc.) a vehicle to be stored inside the interior volume 110.

In some embodiments, the container 75 is sized according to standardized ISO container dimensions including: (i) an external longitudinal length between exterior surfaces of the front wall 90 and the rear wall 95 of 53 feet and an internal longitudinal length between interior surfaces of the front wall 90 and the rear wall 95 of 52 feet 6 inches, (ii) an external lateral width between exterior surfaces of the left wall 80 and the right wall 85 of 8 feet 6 inches and an internal lateral width between interior surfaces of the left wall 80 and the right wall 85 of 8 feet 2 inches, and (iii) an external vertical height between exterior surfaces of the top wall 100 and the bottom wall 105 of 9 feet 6 inches and an internal vertical height between interior surfaces of the top wall 100 and the bottom wall 105 of 8 feet 11 inches. In such embodiments, the door defines an 8 foot 2 inch lateral width and an 8 foot 10 inch vertical height. In other embodiments, the container 75 (and the door) is a different size or dimension. The dimensions of the container 75 may vary depending on the cargo stored in the container 75 and the intended application of the vehicle 10.

### Trailer Defense System

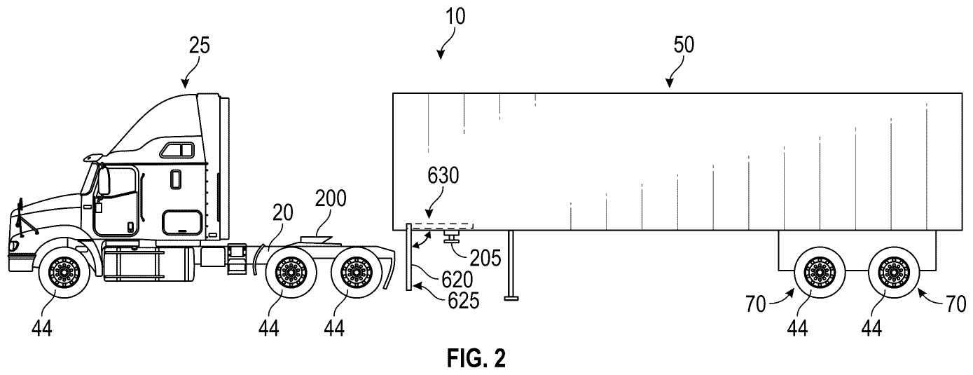

As shown in FIG. 2, the vehicle 10 includes a fifth wheel, shown as coupler 200, coupled to a rear end portion of the chassis 20. The coupler 200 is configured to engage with a trailer engagement feature, shown as kingpin 205, of the trailer 50 to selectively couple the trailer 50 to the chassis 20 of the front end 25 (e.g., selectively couple the trailer 50 to the front end 25 of the vehicle 10). The kingpin 205 extends from the trailer 50 (e.g., from the trailer frame 60 of the trailer 50) in a direction towards the support surface with which the wheel and tire assemblies 44 of the trailer 50 are engaged. The coupler 200 may include an opening configured to receive the kingpin 205 and an engagement mechanism (e.g., a locking mechanism, a rod, a latch, etc.) to secure the kingpin 205 within the opening to couple the trailer 50 to the front end 25 of the vehicle 10. By way of example, the front end 25 of the vehicle 10 reverses to align the coupler 200 (e.g., the opening of the coupler 200) with the kingpin 205 and engage the coupler 200 with the kingpin 205. The kingpin 205 can rotate within the coupler 200 such that the front end 25 of the vehicle 10 and the trailer 50 pivot relative to each other and remain coupled together when the vehicle 10 travels (e.g., when the vehicle 10 travels along a road, when the vehicle 10 turns, when the vehicle 10 reverses, etc.).

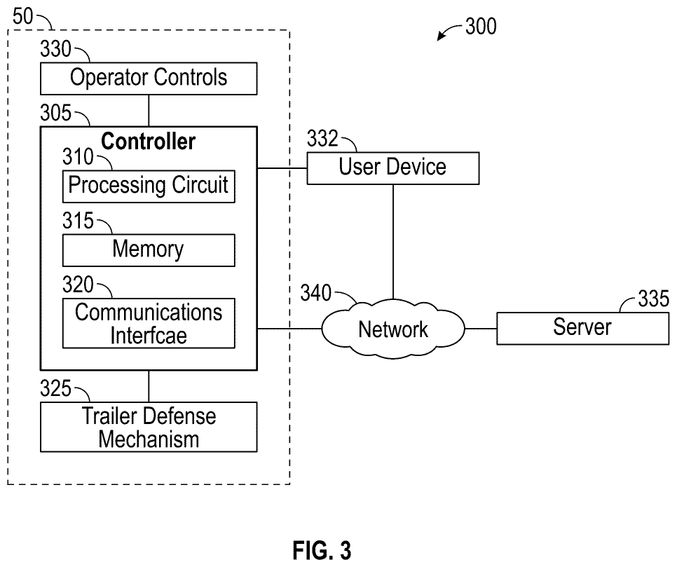

As shown in FIG. 3, a control system (e.g., anti-theft system), shown as trailer defense system 300, includes one or more trailers 50 each including a controller 305 having a processing circuit 310, a memory 315, and a communications interface 320; a trailer defense mechanism 325 fixedly coupled to the trailer 50; an operator interface (e.g., an actuation device, etc.), shown as operator controls 330; a user device 332; and a remote system, shown as server 335, positioned remote or separate from the trailer 50. The one or more trailers 50 and the server 335 communicate via one or more communications protocols (e.g., Bluetooth, Wi-Fi, cellular, radio, through the Internet, etc.) through a network 340.

The controller 305 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 3, the controller 305 includes a processing circuit 310, a memory 315, and a communications interface 320. The processing circuit 310 may include an ASIC, one or more FPGAs, a DSP, circuits containing one or more processing components, circuitry for supporting a microprocessor, a group of processing components, or other suitable electronic processing components. In some embodiments, the processing circuit 310 is configured to execute computer code stored in the memory 315 to facilitate the activities described herein. The memory 315 may be any volatile or non-volatile or non-transitory computer-readable storage medium capable of storing data or computer code relating to the activities described herein. According to an exemplary embodiment, the memory 315 includes computer code modules (e.g., executable code, object code, source code, script code, machine code, etc.) configured for execution by the processing circuit 310. In some embodiments, the controller 305 may represent a collection of processing devices. In such cases, the processing circuit 310 represents the collective processors of the devices, and the memory 315 represents the collective storage devices of the devices.

The controller 305 may be configured to selectively engage, selectively disengage, control, or otherwise communicate with components of the trailer 50 (e.g., via the communications interface 320, a controller area network (“CAN”) bus, etc.). According to an exemplary embodiment, the controller 305 is coupled to (e.g., communicably coupled to) components of the trailer defense mechanism 325, the operator controls 330, and the user device 332. By way of example, the controller 305 may send and receive signals (e.g., control signals) with the components of the trailer defense mechanism 325, the operator controls 330, and/or the user device 332 (e.g., via the communications interface 320).

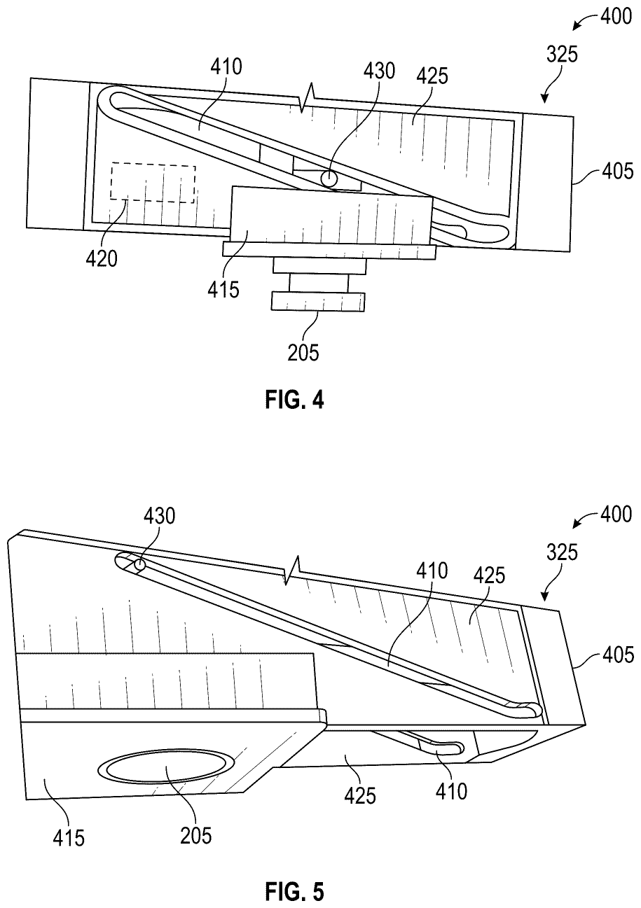

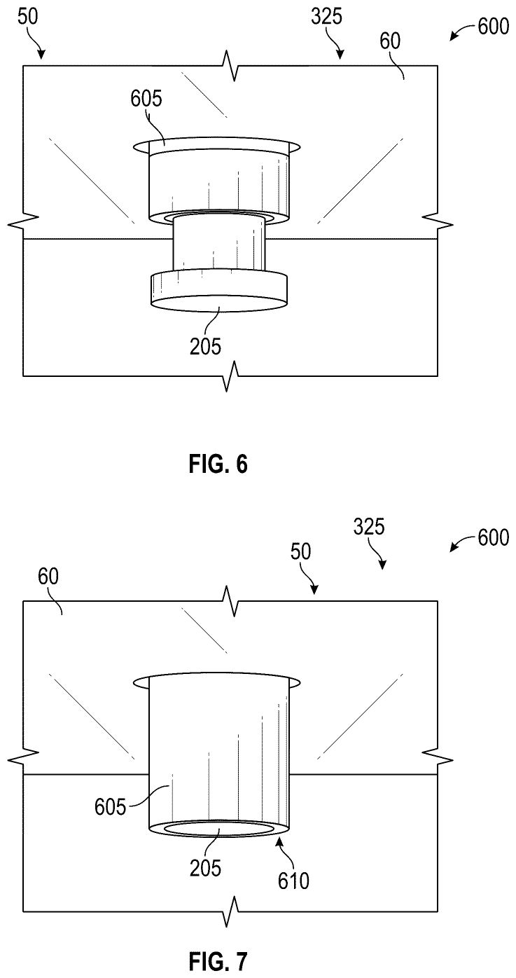

The trailer defense mechanism 325 may be configured to selectively prevent or permit access to the kingpin 205 and/or limit operation of one or more components of the trailer 50. The trailer defense mechanism 325 may be transitionable (e.g., actuatable, engageable, selectively configurable, etc.) between a locked state and an unlocked state. In the unlocked state, the trailer defense mechanism 325 is transitioned such that the kingpin 205 of the trailer 50 is accessible and the coupler 200 can freely engage with the kingpin 205 to couple the trailer 50 to the chassis 20 of the front end 25. In the locked state, the trailer defense mechanism 325 is transitioned such that (i) access to the kingpin 205 is inhibited and the coupler 200 is unable to engage with the kingpin 205 to couple the trailer 50 to the chassis 20 of the front end 25, (ii) engagement of the coupler 200 to the kingpin 205 is made more difficult than if the trailer defense mechanism 325 were not present (e.g., dissuading connection with the trailer 50 even if it is not entirely impossible to connect the coupler 200 to the kingpin 205), or (iii) towing the trailer 50 with the front end 25 is made more difficult (e.g., by limiting one or more operations of the trailer 50). By way of example, as discussed in greater detail with respect to FIGS. 4 and 5 and FIGS. 8-15, in the locked state, the kingpin 205 may be retracted by an actuator (e.g., actuator 420) of the trailer defense mechanism 325 such that a bottom surface (e.g., bottom surface 885) of the kingpin 205 is substantially flush (see, e.g., FIG. 15) with a bottom surface of the trailer defense mechanism 325 (e.g., a bottom surface of the trailer frame 60, the bottom wall 105 of the container 75, a bottom surface of the trailer 50, etc.). By way of another example, as discussed in greater detail with respect to FIGS. 6 and 7, the trailer defense mechanism 325 may include collar, sleeve, tube, etc. configured to selectively deploy over (e.g., encase, surround, etc.) and receive the kingpin 205. In such an example, in the deployed, locked state, the trailer defense mechanism 325 may inhibit access to the kingpin 205 such that the coupler 200 is unable to engage with the kingpin 205 to couple the trailer 50 to the chassis 20 of the front end 25. By way of yet another example, the trailer defense mechanism 325 may include an actuatable member (e.g., the bar 620) configured to selectively actuate between (i) an extended position to block a travel path of the front end 25 such that the front end 25 is unable to position the coupler 200 to engage with the kingpin 205 and (ii) a retracted position to provide a clear travel path for the front end 25 to position to engage the coupler 200 with the kingpin 205. By way of yet another example, when the trailer defense mechanism 325 is in the locked state, one or more operations of the trailer 50 may be limited by the trailer defense mechanism 325. In such an example, in the locked state, the trailer defense mechanism 325 may engage one or more brake systems of the trailer 50 to inhibit rotation of the tire assemblies 44, thereby making towing the trailer 50 more difficult.

The operator controls 330 and the user device 332 may be or include one or more user input devices for receiving input from an operator. The operator controls 330 and the user device 332 may be configured to facilitate the transition of the trailer defense mechanism 325 between (i) the unlocked state to access the kingpin 205 and engage the coupler 200 therewith and (ii) the locked state to prevent access to the kingpin 205 such that the trailer 50 is unable to couple with the chassis 20 of the front end 25. The operator controls 330 and the user device 332 may be communicably coupled with the controller 305 such that, in response to receiving a control signal associated with an actuation command from the operator controls 330 or the user device 332, the controller 305 may control operation of the trailer defense mechanism 325 to transition the trailer defense mechanism 325 between the locked and unlocked states.

As shown in FIG. 3, the operator controls 330 are included with the trailer 50. In some embodiments, the operator controls 330 include a keypad, a human machine interface (HMI) including one or more input controls (e.g., touchscreens, buttons, knobs, dials, etc.), or the like. In some embodiments, the operator controls 330 are mounted (e.g., located, installed, integrated, etc.) along an exterior surface of the trailer 50 (e.g., along the container 75, along the trailer frame 60, etc.). The trailer defense mechanism 325 may be configured to require a password authentication from the operator via the operator controls 330 to transition between the locked state and the unlocked state. The password may depend on the type of the operator controls 330. By way of example, if the operator controls 330 include a keypad and/or HMI, the password may be a sequence of inputs (e.g., a sequence of digits, letters, buttons; a one-time code; a unique identifier; etc.). Responsive to receiving a user input through the input of the operator controls 330, the trailer defense system 300 may compare (e.g., locally via the controller 305, remotely via the server 335, etc.) the user input to a stored authenticator key.

As shown in FIG. 3, the user device 332 is separate from the trailer 50 and is configured to wirelessly communicate with the controller 305 of the trailer 50 (e.g., via the communications interface 320) and/or the server 335 (e.g., via the network 340) to transmit information therebetween. In some embodiments, the user device 332 includes a mobile device (e.g., a smartphone, a tablet, etc.), a smartwatch, a laptop, an RFID tag, an RF signal generator, a capacitive deice, an inductive device, a Bluetooth transmitter, or the like. In some embodiments, the user device 332 includes a tablet or other device used by a driver to perform a plurality of different functions, such as navigation, scheduling, and/or various other functions. In some embodiments, responsive to bringing the user device 332 in proximity to the trailer 50 (e.g., within 5 feet, within 1 foot, within 6 inches, etc.), the trailer defense system 300 may compare (e.g., locally via the controller 305, remotely via the server 335, etc.) a unique identifier associated with the user device 332 (e.g., the unique identifier shared with the controller 305 in response to communication established therebetween) to a stored authenticator key. In some examples, the trailer 50 may include a sensor configured to identify the user device 332 (e.g., an RFID sensor, a barcode/QR code scanner, etc.).

In response to a determination by the controller 305 of the user input matching the stored authenticator key, the controller 305 or the server 335 may transmit a signal to the trailer defense mechanism 325 to transition between the locked state and the unlocked state. The operator controls 330 and/or the user device 332 may give one or more indications that the user input matches the stored authenticator key. By way of example, the operator controls 330 and/or the user device 332 may present an audible indication of a match (e.g., generate and output a tone), a visual indication of a match (e.g., turn on a light), and/or a haptic indication of a match. The operator controls 330 and/or the user device 332 may include an electronic display for presenting information to the operator such as the status of the trailer defense mechanism 325 (e.g., locked state or unlocked state), whether the most recent authentication attempt (e.g., an attempt to access the kingpin 205, an attempt to transition the trailer defense mechanism 325 between the locked state and the unlocked state, etc.) was successful, which operator was authenticated, or any other suitable information.

According to an exemplary embodiment, the server 335 is configured to communicate with one or more trailers 50 and/or user devices 332 via the network 340. By way of example, the server 335 may receive trailer data from the trailer 50 and/or operator data from the user device 332. The server 335 may be configured to perform back-end processing of the trailer data and/or the operator data. The server 335 may be configured to monitor authentication attempts of the trailer defense mechanism 325. In some embodiments, the server 335 is configured to compare a user input to a stored authenticator key responsive to the operator controls 330 receiving the user input. In some embodiments, the server 335 is configured to compare a unique identifier associated with the user device 332 to a stored authenticator key responsive to a communication established between the user device 332 and the controller 305 (e.g., inductive communication, conductive communication, a Bluetooth connection, RF communication, etc.). In response to the user input or the unique identifier matching the stored authenticator key, the server 335 may transmit a signal to the trailer defense mechanism 325 to transition between the locked state and the unlocked state (e.g., to a state indicated by the operator). In some embodiments, after receiving the signal to transition the unlocked state from the locked state, the trailer defense mechanism 325 automatically transitions back to the locked state if the front end 25 has not coupled with the trailer 50 and after a specified amount of time has elapsed (e.g., after 10 minutes, after 15 minutes, etc.). In some embodiments, after the front end 25 has disengaged from the trailer 50 (e.g., disengaged the coupler 200 from the kingpin 205), the trailer defense mechanism 325 automatically transitions to the locked state after a specified amount of time has elapsed.

It should be understood that the server 335 (and any other devices described herein unless indicated otherwise) can be implemented using any hardware and/or software architecture, including, but not limited to, a single computing device (e.g., single server), multiple computing devices (e.g., multiple servers) working together in a distributed computing architecture, cloud computing resources, etc. Further, it should be understood that any of the functions or processes described herein with respect to the trailer defense system 300 may be performed by the controller 305 and/or the server 335. By way of example, data collection may be performed by the controller 305 and data analytics may be performed by the controller 305. By way of another example, data collection may be performed by the controller 305 and data analytics may be performed by the server 335. By way of yet another example, data collection may be performed by the controller 305, a first portion of data analytics may be performed by the controller 305, and a second portion of data analytics may be performed by the server 335. By way of still another example, a first portion of data collection may be performed by the controller 305, a second portion of data collection may be performed by the server 335, and data analytics may be performed by the controller 305 and/or the server 335.

In some embodiments, an authorized user (e.g., a fleet manager, a supervisor, an owner of the trailer 50, etc.) may have access to access permissions. In such embodiments, the authorized user can view, update, delete, or otherwise modify the access permissions data associated with each trailer 50 (e.g., the password associated with the operator controls 330) and/or each user device 332 (e.g., a unique identifier of the user device 332, a user profile logged onto the user device 332, etc.). The server 335 may be configured to provide access to an operator to control the trailer defense mechanism 325. By way of example, the server 335 may transmit an access code (e.g., a password, a code, a QR code, etc.) to the user device 332 (e.g., via a text message) which may be used (e.g., as an input to the operator controls 330) to transition the trailer defense mechanism 325 between the locked state and the unlocked state. In some embodiments, the provided access code is one-time use only such that the access code can only be used once to access the kingpin 205 of a particular trailer 50 (e.g., transition the trailer defense mechanism 325 between the locked state and the unlocked state). In other embodiments, the access code can be used repeatedly to access the kingpin 205 of a particular trailer 50. By way of another example, the server 335 may receive a request (e.g., from the user device 332) to access a trailer defense mechanism 325 of a particular trailer 50 and generate a command to actuate the trailer defense mechanism 325 responsive to an indication that an identifier associated with the request to access matches a stored authenticator key. In some embodiments, the server 335 generates a command actuate the trailer defense mechanism 325 responsive to the authorized user granting access to the guest that requested access.

In some embodiments, the server 335 facilitates access to the trailer defense mechanism 325 of a particular trailer 50 in coordination with a scheduling system. By way of example, the server 335 may control actuation of the trailer defense mechanism 325 based on a schedule of when the trailer defense mechanism 325 may be accessed. The schedule may specify trailer defense mechanism 325 access permissions, e.g., by day of the week, including starting times (hours, minutes, etc.) and ending times (hours, minutes, etc.) for each corresponding permission. In some embodiments, the authorized user can customize a schedule to tailor the schedule as desired. In some embodiments, the server 335 facilitates access to a fleet of trailers 50 each including a trailer defense mechanism 325. By way of example, the server 335 can provide access to a group of trailers 50 coordination with the scheduling system. Further, the server 335 can provide access to a group of trailers 50 located at a particular location.

According to an example embodiment shown in FIGS. 4 and 5, the trailer defense mechanism 325 is configured as a kingpin actuation assembly, shown as kingpin actuator assembly 400. The kingpin actuator assembly 400 is configured to transition (e.g., actuate the kingpin 205) between a locked state (shown in FIG. 5) and an unlocked state (shown in FIG. 4). In the unlocked state, the kingpin actuator assembly 400 actuates such that the kingpin 205 of the trailer 50 is accessible and the coupler 200 can freely engage with the kingpin 205 to couple the trailer 50 to the front end 25. In the locked state, the kingpin actuator assembly 400 actuates such that access to the kingpin 205 is inhibited and the coupler 200 is unable to engage with the kingpin 205 to couple the trailer 50 to the front end 25. The kingpin actuator assembly 400 may be integrally formed with the trailer 50 (e.g., fixedly coupled with the trailer 50 during manufacturing thereof, fixedly retrofit to the trailer 50, etc.). The kingpin actuator assembly 400 may be positioned along a bottom surface of the trailer 50 and proximate a front end of the trailer 50 such that when the kingpin actuator assembly 400 is in the unlocked state and the kingpin 205 is accessible, the front end 25 can be positioned to engage the coupler 200 with the kingpin 205.

As shown in FIGS. 4 and 5, the kingpin actuator assembly 400 includes a housing 405 defining one or more slots 410; a slide 415 slidably coupled with the housing 405; and an actuator 420. The slots 410 may be arranged along opposing sidewalls 425 of the housing 405. In some embodiments, the housing 405 is arranged such that the sidewalls 425 extend in a longitudinal direction (e.g., in a direction between the front wall 90 and the rear wall 95) and are laterally spaced apart (e.g., in a lateral direction between the left wall 80 and the right wall 85). The slots 410 define openings that extend diagonally at an angle relative to a bottom edge of the housing 405 and along the sidewalls 425 thereof. By way of example, the slots 410 may extend between bottom, rear corners of the sidewalls 425 and top, front corners of the sidewalls 425. The actuator 420 may include linear actuators (e.g., electric linear actuators, hydraulic cylinders, etc.), motors (e.g., electric motors, hydraulic motors, pneumatic motors, etc.), or other types of actuators. The actuator 420 may be electrically powered, hydraulically powered, or otherwise powered. In some embodiments, the actuator 420 is an electric motor powered by an electrical energy source (e.g., batteries, energy from a power grid external to the vehicle 10, etc.).

As shown in FIGS. 4 and 5, the slide 415 is slidably coupled (e.g., engaged) with the housing 405 and configured to longitudinally or laterally (e.g., based on the orientation of the housing 405) translate along the bottom surface of the housing 405 while remaining coupled therewith. In some embodiments, the actuator 420 is mechanically coupled with the slide 415 and/or the kingpin 205 to cause the slide 415 and the kingpin 205 coupled therewith to translate, thereby transitioning the kingpin actuator assembly 400 between the locked state and the unlocked state. In some embodiments, the actuator 420 is configured actuate to transition the kingpin actuator assembly 400 between the locked state and the unlocked state in response to a command signal received from the controller 305 and/or the server 335, as discussed in greater detail above with respect to FIG. 3.

The slide 415 includes an aperture along a bottom surface thereof configured to receive at least a portion of the kingpin 205. The kingpin 205 may be arranged within the opening of the slide 415 such that the kingpin 205 can translate (i) in a vertical direction within the opening of slide 415 and (ii) in a longitudinal direction or a lateral direction in coordination with the slide 415. The kingpin 205 extends through the slide 415 such that at least a portion of the kingpin 205 is disposed within the housing 405. The portion of the kingpin 205 disposed within the housing 405 includes one or more engagement features 430 configured to be received within the slots 410. As the slide 415 translates, the engagement features 430 remain received within the slots 410 and translate within the slots 410 (e.g., the engagement features 430 follow the diagonal path defined by the slots 410). In this manner, as the slide 415 translates relative to the housing 405, the engagement between the engagement features 430 and the slots 410 facilitate vertical translation of the kingpin 205. In some embodiments, the slots 410 are otherwise suitably arranged to receive the engagement features 430 and facilitate vertical translation of the kingpin 205.

As shown in FIG. 4, the kingpin actuator assembly 400 is arranged in the unlocked state. In the unlocked state, the slide 415 is positioned at a first position (e.g., a first longitudinal position or a first lateral position) and the kingpin 205 is in an extended position. As shown in FIG. 5, the kingpin actuator assembly 400 is arranged in the locked state. By way of example, in response to receiving an actuation command, the actuator 420 is configured to actuate to transition the kingpin actuator assembly 400 from the unlocked state to the locked state. In the locked state, the slide 415 is positioned at a second position (e.g., a second longitudinal position or a second lateral position) and the kingpin 205 is in a retracted position. In other words, to transition the kingpin actuator assembly 400 between the unlocked state and the locked state, the actuator 420 actuates to move the slide 415 between the first position and the second position and, correspondingly, the kingpin 205 between the extended position and the retracted position while the housing 405 remains stationary.

In the retracted position, a bottom surface of the kingpin 205 may be substantially flush with the slide 415 (e.g., a bottom surface of the trailer frame 60, the bottom wall 105 of the container 75, a bottom surface of the trailer 50, etc.). In the retracted position, the kingpin 205 is inaccessible (e.g., from an exterior of the trailer 50) and the coupler 200 is unable to engage with the kingpin 205 to couple the trailer 50 to the front end 25. In some embodiments, the kingpin actuator assembly 400 can be in the locked state even if the kingpin 205 is not fully retracted to the retracted position as shown in FIG. 5. By way of example, the actuator 420 can actuate to move the kingpin 205 and the slide 415 to a position where the kingpin 205 is not flush with the slide 415, but is still inaccessible such that the coupler 200 is unable to engage with the kingpin 205 to couple the trailer 50 to the front end 25.

According to an example embodiment, the trailer defense mechanism 325 (e.g., the kingpin actuator assembly 400) includes the actuator 420 configured to provide rotational motion to the kingpin 205 to transition the kingpin 205 between a retracted position (e.g., the locked state) and an extended position (e.g., the unlocked state). By way of example, the kingpin 205 may include external threads configured to engage with internal threads of the housing 405 to enable the kingpin 205 to rotate between the retracted position and the extended position. In the retracted position, at least a portion of the kingpin 205 may be received within the housing 405 such that the kingpin 205 is inaccessible and the coupler 200 is unable to engage with the kingpin 205 to couple the trailer 50 to the front end 25.

According to another example embodiment shown in FIGS. 6 and 7, the trailer defense mechanism 325 is configured as a sleeve actuation assembly 600. The sleeve actuation assembly 600 is configured to transition (e.g., actuate the sleeve 605) between a locked state (shown in FIG. 7) and an unlocked state (shown in FIG. 6). The sleeve actuation assembly 600 includes a sleeve 605 (e.g., collar, guard, tube, etc.) actuatable (e.g., actuatable by an actuator such as actuator 420) between a retracted position and an extended position. The sleeve 605 may be substantially cylindrically shaped. In other embodiments, the sleeve 605 is otherwise shaped (e.g., cuboidal). The sleeve 605 may include an interior cavity 610 configured to receive at least a portion of the kingpin 205. In the locked state, the sleeve 605 is actuated (e.g., by an actuator) to the extended position such that the sleeve 605 is deployed around the kingpin 205 and receives at least a portion of the kingpin 205 within the interior cavity 610, thereby inhibiting access to the kingpin 205 such that the coupler 200 is unable to engage with the kingpin 205 to couple the trailer 50 to the front end 25. In some embodiments, the sleeve 605 is actuated such that the entire length of the kingpin 205 is received within the sleeve 605. In other embodiments, the sleeve 605 is otherwise actuated to a suitable position to inhibit access to the kingpin 205. In the unlocked state, the sleeve 605 is actuated to the retracted position such that the kingpin 205 of the trailer 50 is accessible and the coupler 200 can freely engage with the kingpin 205 to couple the trailer 50 to the front end 25.

Referring back to FIG. 2, the trailer defense mechanism 325 may include an actuatable member, shown as bar 620, coupled with the trailer 50. The bar 620 may be configured to actuate (e.g., pivot, linearly extend/retract, etc.) relative to the trailer 50 between an extended position 625 (e.g., the locked state) and a retracted position 630 (e.g., the unlocked state). The bar 620 may pivot (e.g., as shown by the arrows in FIG. 2) or linearly extend/retract responsive to being actuated by an actuator (e.g., actuator 420) and/or be manually actuated by an operator between the extended position 625 and the retracted position 630. In the extended position 625, the bar 620 is configured to extend in a direction away from the trailer 50 and positioned to inhibit the front end 25 from coupling with the kingpin 205. By way of example, in the extended position 625 the bar 620 extends from the trailer 50 to block a travel path (e.g., a path along which the front end 25 travels to engage the coupler 200 with the kingpin 205) of the front end 25 such that the front end 25 is unable to position the coupler 200 to engage with the kingpin 205 (e.g., without contacting the bar 620). In the retracted position 630, the bar 620 is configured to extend along the trailer 50, or otherwise retract (e.g., into a cavity along the bottom surface of the trailer 50), to provide a clear travel path for the front end 25 to position to engage the coupler 200 with the kingpin 205. The bar 620 may be suitably dimensioned to inhibit the front end 25 from coupling with the kingpin 205 in the extended position. By way of example, the bar 620 may define a length substantially similar to a length of the kingpin 205. By way of another example, the bar 620 may define a length substantially similar to a distance between a bottom surface of the trailer 50 and the ground surface (e.g., when the trailer 50 is parked and disconnected from the front end 25).

According to another example embodiment, the trailer 50 includes a brake system that is pneumatically controlled. The trailer 50 includes connectors (e.g., gladhands, conduits, etc.) configured to couple with the front end 25 (e.g., when the coupler 200 is engaged with the kingpin 205) to facilitate a transfer of fluid power (e.g., hydraulic power, pneumatic power, etc.), electrical energy (e.g., electrical power), and/or information between the front end 25 and the trailer 50. When the trailer 50 is parked, the front end 25 may provide pneumatic power to the brake system of the trailer 50 before disconnecting from the trailer 50 (e.g., before disconnecting the gladhands, before disengaging the coupler 200 from the kingpin 205) to engage the brake system. The trailer defense mechanism 325 may be configured to control one or more components of the trailer 50. By way of example, when the trailer defense mechanism 325 is in the locked state, one or more operations of the trailer 50 may be limited by the trailer defense mechanism 325. In such an example, in the locked state, the trailer defense mechanism 325 may engage one or more brake systems of the trailer 50 to inhibit rotation of the tire assemblies 44, thereby making towing the trailer 50 more difficult. In this manner, when the trailer 50 is disconnected from the front end 25, the brake system of the trailer 50 is engaged (e.g., rotation of the tire assemblies 44 of the trailer 50 is inhibited) to inhibit or otherwise dissuade an unauthorized operator (e.g., an unauthorized front end 25) from stealing the trailer 50.

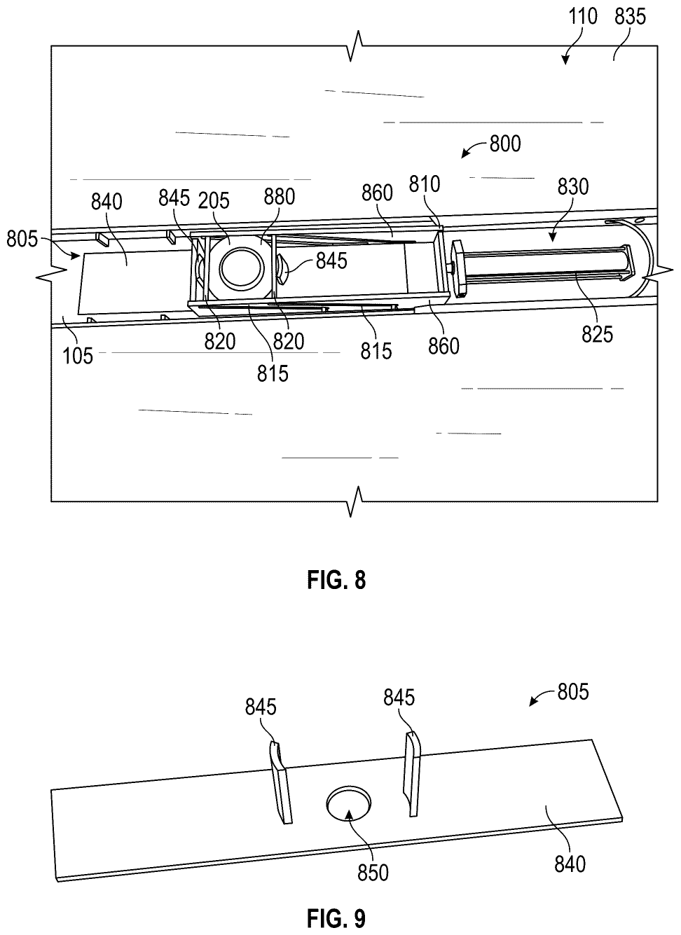

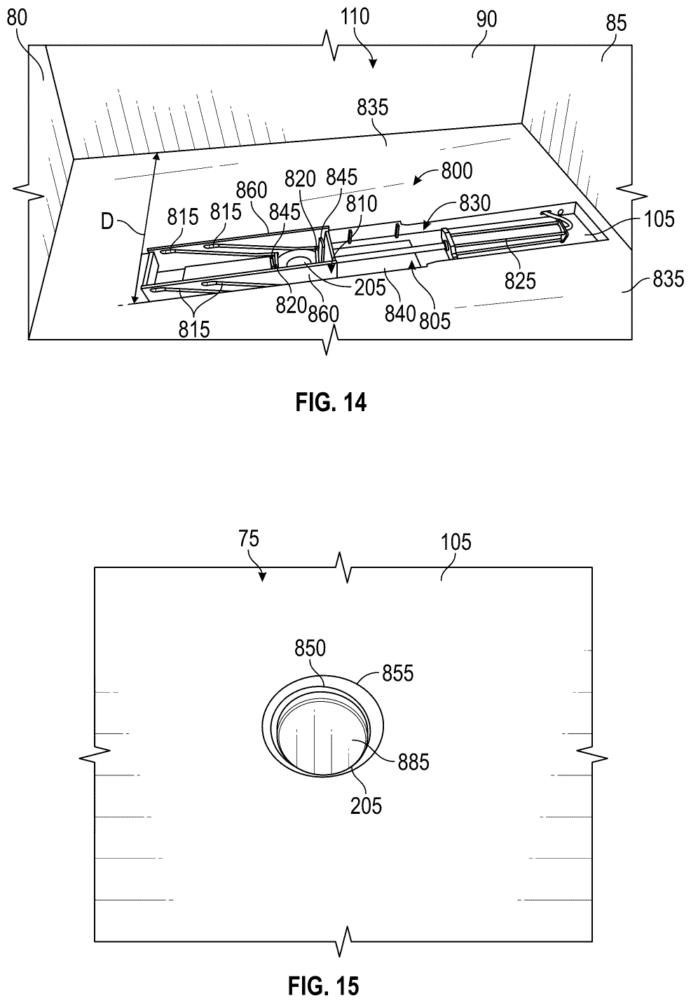

According to an example embodiment shown in FIGS. 8-14, the trailer defense mechanism 325 is configured as a kingpin housing actuation assembly, shown as kingpin actuator assembly 800. The kingpin actuator assembly 800 includes a base (e.g., base plate), shown as base support 805, coupled to the bottom wall 105 (or a floor surface thereon) of the trailer 50; a support structure, shown as housing 810, defining one or more openings (e.g., slits, apertures, guides, channel, etc.), shown as slots 815; one or more engagement features (e.g., pins, rods, etc.), shown as engagement features 820, slidably coupled with the housing 810; and an actuator 825. The kingpin actuator assembly 800 is configured to transition (e.g., actuate the kingpin 205) between a locked state (shown in FIG. 8) and an unlocked state (shown in FIG. 14). In the unlocked state, the kingpin actuator assembly 800 actuates such that the kingpin 205 of the trailer 50 is accessible and the coupler 200 can freely engage with the kingpin 205 to couple the trailer 50 to the front end 25. In the locked state, the kingpin actuator assembly 800 actuates such that access to the kingpin 205 is inhibited and the coupler 200 is unable to engage with the kingpin 205 to couple the trailer 50 to the front end 25. In some embodiments, the kingpin actuator assembly 800 is integrally formed with the trailer 50 (e.g., fixedly coupled with the trailer 50 during manufacturing thereof, fixedly retrofit to the trailer 50, etc.). In such embodiments, the bottom wall 105 of the trailer 50 may be lower (e.g., closer to a ground surface on which the vehicle 10 travels) than a traditional trailer without the kingpin actuator assembly 800. As such, the height of the coupler 200 may be closer to the ground surface to accommodate for the lowered height of the bottom wall 105.

As shown in FIGS. 8 and 12-14, the kingpin actuator assembly 800 is positioned within the interior volume 110 of the container 75 along a bottom surface thereof. Specifically, the kingpin actuator assembly 800 is positioned, at least partially, within an interior cavity (e.g., cutout), shown as cavity 830, along the bottom surface of the container 75. As shown in FIGS. 8 and 12-15, the container 75 includes the bottom wall 105 and a floor, shown as floor surface 835, positioned within the interior volume 110 and spaced vertically above the bottom wall 105. The floor surface 835 is configured to support cargo within the interior volume 110. The floor surface 835 includes a cutout such that the bottom wall 105 and the space between the bottom wall 105 and the floor surface 835 define the cavity 830. As discussed in greater detail below, in a retrofit installation of the kingpin actuator assembly 800, the floor surface 835 and one or more bracings (e.g., supports, frames, rails, etc.) positioned between the floor surface 835 and the bottom wall 105 may be cut to form the cavity 830. In other embodiments, the kingpin actuator assembly 800 is positioned between the floor surface 835 and the bottom wall 105 during manufacturing of the trailer 50.

As shown in FIGS. 13 and 14, the kingpin actuator assembly 800 is positioned proximate a front end of the trailer 50 (e.g., proximate the front wall 90) such that when the kingpin actuator assembly 800 is in the unlocked state and the kingpin 205 is accessible, the front end 25 can be positioned to engage the coupler 200 with the kingpin 205. As shown in FIG. 14, a rear edge of the kingpin actuator assembly 800 (e.g., an edge of the kingpin actuator assembly 800 closest to the rear wall 95 of the trailer 50) is spaced a longitudinal distance, shown as distance D, from the front wall 90 (or a wall surface thereon). In some embodiments, the distance D is about 48 inches. In other embodiments, the distance D is greater than 48 inches (e.g., 50 inches, 55 inches, 60 inches, etc.) or less than 48 inches (e.g., 45 inches, 40 inches, 36 inches, etc.).

As shown in FIGS. 8, 9, 13, and 14, the base support 805 includes a plate, shown as base plate 840, and one or more support members, shown as kingpin supports 845. The kingpin supports 845 are configured to fixedly couple to the base plate 840 and extend a vertical direction therefrom. In some embodiments, the kingpin supports 845 are welded to the base plate 840. In other embodiments, the kingpin supports 845 are integrally formed with the base plate 840 as a single, unitary body. As shown in FIGS. 8, 9, 13, and 14, the kingpin supports 845 are laterally spaced apart from each other along the base plate 840. The kingpin supports 845 are spaced to define a channel therebetween sized to receive the kingpin 205. By way of example, the kingpin 205 may be received laterally between the kingpin supports 845 such that the kingpin supports 845 contact the kingpin 205 (e.g., to inhibit lateral movement of the kingpin 205 relative to the kingpin supports 845 as discussed in greater detail below). As shown in FIGS. 9 and 13, the base support 805 includes an opening (e.g., hole, aperture, cutout, etc.), shown as opening 850. The opening 850 is positioned along the base plate 840 between the kingpin supports 845. The opening 850 is configured to receive the kingpin 205. By way of example, the opening 850 may be sized complementary to or larger than the kingpin 205 such that, during operation of the kingpin actuator assembly 800, the kingpin 205 can vertically translate within the opening 850. As shown in FIGS. 8, 9, 13, and 14, the kingpin supports 845 define an arced (e.g., curved, bent, circular, ovular, etc.) profile. In some embodiments, the arced profile is complementary to a profile of the kingpin 205. By way of example, collectively, the kingpin supports 845 may define a channel configured to receive the kingpin 205, and the channel may be shaped complementary to the profile of the kingpin 205 (e.g., the arced profile of the kingpin supports 845). In other embodiments, the kingpin supports 845 are otherwise shaped (e.g., flat, square, rectangular, etc.) to inhibit lateral movement of the kingpin 205 relative to the kingpin supports 845.

In some embodiments, in a retrofit installation of the kingpin actuator assembly 800, the base support 805 (e.g., the base plate 840) is coupled (e.g., welded) to a top surface of the bottom wall 105 within the cavity 830. The base support 805 may be positioned such that the opening 850 is aligned with (e.g., concentric, coaxial, etc.) an opening (e.g., hole, aperture, cutout, etc.), shown as kingpin opening 855, in the bottom wall 105. As shown in FIG. 15, the opening 850 and the kingpin opening 855 are configured to cooperatively receive the kingpin 205 such that, during operation of the kingpin actuator assembly 800, the kingpin 205 can vertically translate within the opening 850 and the kingpin opening 855. In other embodiments, the base support 805 is integrally formed with the bottom wall 105 during manufacturing of the trailer 50. In such embodiments, the base support 805 may omit the base plate 840 and only include the kingpin supports 845.

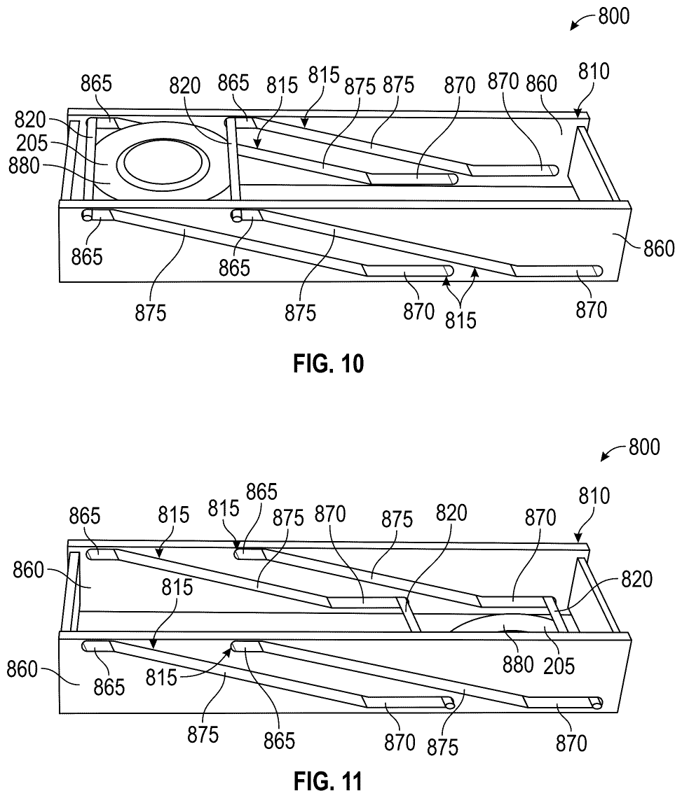

As shown in FIGS. 10 and 11, the slots 815 are arranged along opposing sidewalls, shown as sidewalls 860 of the housing 810. Each sidewall 860 of the housing 810 includes two slots 815 offset from each other. The slots 815 extend between bottom, rear corners of the sidewalls 860 to top, front corners of the sidewalls 860. The slots 815 include a first portion, shown as first plateau portion 865, a second portion, shown as second plateau portion 870, and a third portion, shown as diagonal portion 875. The diagonal portion 875 extends diagonally at an angle relative to a bottom edge of the housing 810 and along the sidewalls 860 thereof between the first plateau portion 865 and the second plateau portion 870. The first plateau portion 865 extends along a top edge of the sidewalls 860 of the housing 810 in a lateral direction and is substantially parallel with the top edge. The second plateau portion 870 extends along a bottom edge of the sidewalls 860 of the housing 810 in the lateral direction and is substantially parallel with the bottom edge (and the first plateau portion 865). As shown in FIGS. 10 and 11, the first plateau portion 865 defines a lateral length that is less than a lateral length of the second plateau portion 870. In some embodiments, the first plateau portion 865 defines a lateral length that is larger than a lateral length of the second plateau portion 870. In other embodiments, the first plateau portion 865 defines a lateral length that is substantially equal to a lateral length of the second plateau portion 870.

As shown in FIGS. 8, 10, 11, and 14, the engagement features 820 are configured to couple to a top surface 880 of the kingpin 205. In some embodiments, the engagement features 820 are welded to the top surface 880. In other embodiments, the engagement features 820 are integrally formed with the kingpin 205 along the top surface 880 as a single, unitary body. As shown in FIGS. 8, 10, 11, and 14, the engagement features 820 are positioned along the top surface 880 along opposing lateral sides thereof. The engagement features 820 extend in a longitudinal direction beyond the longitudinal length of the top surface 880 such that the engagement features 820 are received within the slots 815 and the kingpin 205 is positioned longitudinally between the sidewalls 860 of the housing 810.

As shown in FIGS. 10 and 11, the engagement features 820 are configured to be received within the slots 815 (e.g., slidably coupled with the slots 815) such that the kingpin 205 and the housing 810 can move relative to each other. In other words, the engagement features 820 coupled with the kingpin 205 are received within the slots 815 such that the kingpin 205 is positioned longitudinally between the sidewalls 860 of the housing 810. In some embodiments, one or more edges of the top surface 880 of the kingpin 205 are machined (e.g., cut) to reduce a longitudinal length (e.g., diameter) of the kingpin 205 such that the kingpin 205 can be received within the housing 810 and between the sidewalls 860. In other embodiments, the kingpin 205 and/or the housing 810 are dimensioned during the manufacturing thereof such that the kingpin 205 can be received within the housing 810 and between the sidewalls 860.

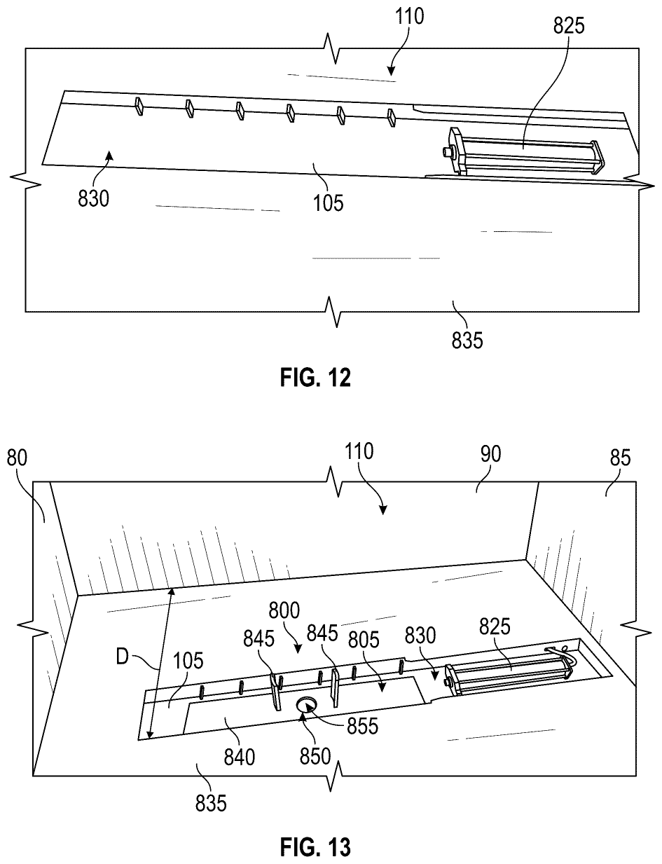

As shown in FIGS. 12, 13, and 14, the actuator 825 is configured to couple with the housing 810 to translate the housing 810 in a lateral direction (e.g., in a direction between the left wall 80 and the right wall 85). In some embodiments, the housing 810, the actuator 825, and the cavity 830 are arranged (e.g., oriented) such that the housing 810 translates in a longitudinal direction (e.g., in a direction between the front wall 90 and the rear wall 95). The actuator 825 may include linear actuators (e.g., electric linear actuators, hydraulic cylinders, etc.), motors (e.g., electric motors, hydraulic motors, pneumatic motors, etc.), or other types of actuators. The actuator 825 may be electrically powered, hydraulically powered, or otherwise powered. In some embodiments, the actuator 825 includes an electric motor powered by an electrical energy source By way of example, the actuator 825 may include one or more batteries configured to provide power to actuate the actuator 825 between an extended position (see, e.g., FIG. 14) and a retracted position (see, e.g., FIGS. 8, 12, and 13). By way of another example, the actuator 825 may receive electrical energy from an electrical connection with the front end 25 of the vehicle 10 (e.g., the front end 25 including one or more batteries, the front end 25 including an alternator configured to generate electrical energy from an engine of the vehicle 10, the front end 25 electrically coupled with a power grid external to the vehicle 10, etc.). In some embodiments, the actuator 825 is configured to receive pneumatic power and/or hydraulic power from the front end 25 of the vehicle 10 via a pneumatic and/or hydraulic connection therewith. In some embodiments, the actuator 825 is configured actuate in response to a command signal received from the controller 305 and/or the server 335, as discussed in greater detail above with respect to FIG. 3.

As shown in FIGS. 8, 12, 13, and 14, the actuator 825 is positioned within the cavity 830 and configured to engage with the housing 810. The actuator 825 is coupled with the housing 810 and is configured to actuate between the retracted position shown in FIGS. 8, 12, and 13 to the extended position shown in FIG. 14 to cause the housing 810 coupled therewith to translate between a first position shown in FIG. 8 and a second position shown in FIG. 14, thereby transitioning the kingpin actuator assembly 800 between the locked state and the unlocked state. As shown in FIGS. 8, 13, and 14, the base support 805 is positioned within the cavity 830 such that the opening 850 is aligned with the kingpin opening 855. As shown in FIGS. 8, 10, 11, and 14, the engagement features 820 coupled to the kingpin 205 are received within the slots 815 (e.g., slidably coupled with the slots 815) of the housing 810 such that the kingpin 205 and the housing 810 can move relative to each other.

As shown in FIGS. 8 and 14, the housing 810 is positioned within the cavity 830 such that the kingpin 205 is arranged within the opening 850 and the kingpin opening 855. As such, the kingpin 205 can translate in a vertical direction within the opening 850 and the kingpin opening 855. As shown in FIGS. 8 and 14, the housing 810 is positioned within the cavity 830 such that the kingpin 205 and the engagement features 820 are positioned laterally between the kingpin supports 845. The kingpin supports 845 are configured to engage with at least one of the kingpin 205 or the engagement features 820 to inhibit lateral translation thereof as the actuator 825 actuates between the extended position and the retracted position to move the housing 810 between the second position and the first position, respectively. In response to actuating the actuator 825, the housing 810 laterally translates, and the engagement features 820 remain received within the slots 815 and translate within the slots 815 (e.g., the engagement features 820 follow a path (i.e., the first plateau portion 865, the second plateau portion 870, and the diagonal portion 875) defined by the slots 815 as the housing 810 translates relative thereto). In this manner, as the housing 810 laterally translates relative to the base support 805, the kingpin 205, and the engagement features 820, the engagement between (i) the kingpin supports 845 and the kingpin 205 and/or the engagement features 820 inhibit lateral translation thereof with the housing 810, and (ii) the engagement features 820 and the slots 815 facilitate vertical translation of the kingpin 205. In some embodiments, the slots 815 are otherwise suitably arranged to receive the engagement features 820 and facilitate vertical translation of the kingpin 205. Although the kingpin actuator assembly 800 is shown in FIGS. 8 and 12-14 arranged within the interior volume 110 of the container 75 such that the actuator 825 translates the housing 810 in a lateral direction, it should be understood that the kingpin actuator assembly 800 may be arranged such that the actuator 825 translates the housing 810 in a longitudinal direction, or any other direction. Further, although the kingpin actuator assembly 800 is shown in FIGS. 8 and 12-14 arranged within the interior volume 110 of the container 75 such that the actuator 825 translates the housing 810 in a lateral direction towards the left wall 80 to transition the housing 810 from the first position to the second position, it should be understood that the kingpin actuator assembly 800 may be arranged such that the actuator 825 translates the housing 810 in a lateral direction towards the right wall 85 to transition the housing 810 from the first position to the second position.

As shown in FIG. 14, the kingpin actuator assembly 800 is arranged in the unlocked state. In the unlocked state, the housing 810 is positioned at the second position, the actuator 825 is in an extended position, and the kingpin 205 is in an extended position. As shown in FIG. 11, the housing 810 is positioned at the second position such that the engagement features 820 are received within the slots 815 along the second plateau portion 870. The second plateau portion 870 may facilitate retaining the engagement features 820 therein (e.g., keeping the housing 810 in the second position and the kingpin 205 in the extended position) in response to a vertically upward force applied to a bottom surface 885 of the kingpin 205. By way of example, when the kingpin 205 is in the extended position and a vertically upward force is applied to the bottom surface 885 (e.g., from outside of the container 75), the engagement features 820 may engage with the sidewalls 860 (e.g., an upper surface of the slots 815). In such an example, because the second plateau portion 870 is substantially flat, the vertically upward force applied to the bottom surface 885 will not cause the engagement features 820 to slide within the slots 815 (e.g., along the diagonal portion 875) to transition the housing 810 to the first position and the kingpin 205 to the retracted position.

As shown in FIGS. 8 and 15, the kingpin actuator assembly 800 is arranged in the locked state. In the locked state, the housing 810 is positioned at the first position, the actuator 825 is in a retracted position, and the kingpin 205 is in a retracted position. As shown in FIG. 10, the housing 810 is positioned at the first position such that the engagement features 820 are received within the slots 815 along the first plateau portion 865. The first plateau portion 865 may facilitate retaining the engagement features 820 therein (e.g., keeping the housing 810 in the first position and the kingpin 205 in the retracted position) in response to a vertically downward force applied to the kingpin 205. By way of example, when the kingpin 205 is in the retracted position and a vertically downward force is applied to the kingpin 205 (e.g., in an attempt to retract the kingpin 205 from outside of the container 75), the engagement features 820 may engage with the sidewalls 860 (e.g., a lower surface of the slots 815). In such an example, because the first plateau portion 865 is substantially flat, the vertically downward force applied to the kingpin 205 will not cause the engagement features 820 to slide within the slots 815 (e.g., along the diagonal portion 875) to transition the housing 810 to the second position and the kingpin 205 to the extended position. Accordingly, the structure of the slots 815 facilitates retaining the kingpin actuator assembly 800 in the locked state to prevent an attempt to retract the kingpin 205 from outside of the container 75 and transition the kingpin actuator assembly 800 to the unlocked state.

In some embodiments, in response to receiving an actuation command, the actuator 825 is configured to actuate to transition the kingpin actuator assembly 800 from the unlocked state to the locked state. In other words, to transition the kingpin actuator assembly 800 between the unlocked state and the locked state, the actuator 825 actuates to move the housing 810 between the second position and the first position and, correspondingly, the kingpin 205 between the extended position and the retracted position while the base support 805 and the kingpin 205 remain laterally stationary.

In the retracted position, the bottom surface 885 of the kingpin 205 may be substantially flush (see, e.g., FIG. 15) with the bottom wall 105 (e.g., a bottom surface of the trailer frame 60, a bottom surface of the trailer 50, etc.). In the retracted position, the kingpin 205 is inaccessible (e.g., from an exterior of the trailer 50) and the coupler 200 is unable to engage with the kingpin 205 to couple the trailer 50 to the front end 25. In some embodiments, the kingpin actuator assembly 800 can be in the locked state even if the kingpin 205 is not fully retracted to the retracted position as shown in FIGS. 8 and 15. By way of example, the actuator 825 can actuate to laterally move the housing 810 and, correspondingly, vertically move the kingpin 205 to a position where the kingpin 205 is not flush with the bottom wall 105, but is still inaccessible such that the coupler 200 is unable to engage with the kingpin 205 to couple the trailer 50 to the front end 25.

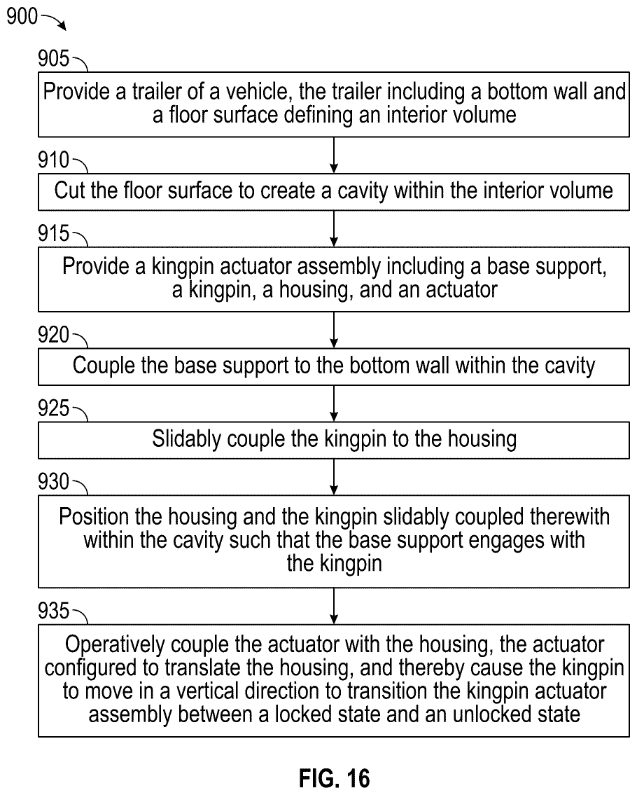

As shown in FIG. 16, a retrofit method 900 outlines steps for installing the kingpin actuator assembly 800 onto a trailer (e.g., the trailer 50, retrofitting the trailer with the kingpin actuator assembly 800, etc.). As step 905, a trailer (e.g., a traditional trailer without the kingpin actuator assembly 800 preinstalled thereon or manufactured therewith, the trailer 50, etc.) is provided. The trailer may include sidewalls (e.g., a left wall, a right wall, a front wall, a rear wall, etc.), a top wall, and a bottom wall defining an interior volume (e.g., interior volume 110). The trailer may include a floor surface (e.g., floor surface 835) positioned along the bottom floor and vertically spaced from the bottom floor.

At step 910, a cavity (e.g., cavity 830) is provided within the floor surface of the interior volume. In some embodiments, the floor surface is cut to create the cavity. The floor surface may be cut such that the bottom wall and the space between the bottom wall and the floor surface define the cavity. In some embodiments, the trailer includes one or more bracings positioned between the floor surface and the bottom wall. In such embodiments, the bracings may be cut to form the cavity. The cavity may be sized to receive a kingpin actuator assembly (e.g., kingpin actuator assembly 800).

At step 915, the kingpin actuator assembly including a base support (e.g., base support 805), a kingpin (e.g., kingpin 205), and a housing (e.g., housing 810) is provided. The base support may include a base plate (e.g., base plate 840) defining an opening (e.g., opening 850) and kingpin supports (e.g., kingpin supports 845). The kingpin supports may be spaced apart from each other and may extend in a vertical direction from the base plate. The opening may be positioned along the base plate between the kingpin supports. The opening may be sized to receive the kingpin. The kingpin may be configured to selectively couple the trailer to a front end (e.g., front end 25) of a vehicle (e.g., vehicle 10). The kingpin can rotate within a coupler (e.g., coupler 200) such that the front end of the vehicle and the trailer pivot relative to each other and remain coupled together when the vehicle travels. The housing may include sidewalls (e.g., sidewalls 860) defining slots (e.g., slots 815) extending along the sidewalls. The slots may extend between bottom, rear corners of the sidewalls to top, front corners of the sidewalls.

At step 920, the base support is coupled to the bottom wall within the cavity. The base support may be coupled (e.g., welded) to the bottom wall such that the base support is fixed relative to the bottom wall. The base support may be positioned such that the opening thereof is aligned with a kingpin opening (e.g., kingpin opening 855) of the bottom wall. Collectively, the opening and the kingpin opening may receive the kingpin and permit vertical translation kingpin within the opening and the kingpin opening.

At step 925, the kingpin and the housing are slidably coupled together. The kingpin may be cut out of the trailer. The kingpin may include engagement features (e.g., engagement features 820) coupled (e.g., welded) to the top surface thereof. The engagement features may extend within the slots of the housing such that the housing can translate relative to the kingpin. The slots are shaped (e.g., defining a diagonal path) such that as the housing is moved, the engagement features engage with the sidewalls of the housing within the slots and follow the path of the slots, thereby causing vertical movement of the kingpin.

At step 930, the housing and the kingpin slidably coupled therewith are positioned within the cavity such that the base support engages with the kingpin. Specifically, the kingpin is positioned between the kingpin supports and within the opening of the base support. The kingpin supports may engage with the kingpin or the engagement features to inhibit lateral translation thereof as the housing is laterally translated.

At step 935, an actuator (e.g., actuator 825) is operatively coupled with the housing. The actuator may retract and extend to translate the housing between a first position and a second position, and thereby transition the kingpin actuator assembly between a locked state and an unlocked state. The actuator may include linear actuators (e.g., electric linear actuators, hydraulic cylinders, etc.), motors (e.g., electric motors, hydraulic motors, pneumatic motors, etc.), or other types of actuators. In the first position, the housing is positioned such that the engagement between the engagement features and the slots causes the kingpin to vertically move to an extended position. In the extended position, the kingpin is accessible (e.g., from an exterior of the trailer) and the coupler is able to engage with the kingpin to couple the trailer to the front end. In the second position, the housing is positioned such that the engagement between the engagement features and the slots causes the kingpin to vertically move to a retracted position. In the retracted position, the kingpin is inaccessible (e.g., from an exterior of the trailer) and the coupler is unable to engage with the kingpin to couple the trailer to the front end. In some embodiments, the actuator is received within the cavity. In some embodiments, after installing the kingpin actuator assembly within the interior volume of the trailer, a cover is placed on top of the kingpin actuator assembly to inhibit access to the kingpin actuator assembly from the interior volume. In some embodiments, the housing extends about 1.5 inches above the floor surface. In such embodiments, the cover may be placed over the kingpin actuator assembly and may include a ramped surface to facilitate overcoming the height difference between the housing and the floor surface. By way of example, a front edge and a rear edge of the cover may be angled to facilitate loading and unloading cargo on top of the cover. In such an example, the ramp may provide a surface to load (e.g., guide, direct, unload, drive, roll, etc.) freight to be stored inside the interior volume without getting caught on the housing because of the height difference. In other embodiments, the housing is flush with the floor surface.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10, the trailer defense system 300, and the trailer defense mechanism 325 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A trailer defense system comprising:
a trailer defense mechanism configured to couple with or be integrated within a trailer, the trailer defense mechanism including:
a housing including sidewalls spaced apart from each other, the sidewalls defining one or more slots;
one or more engagement features configured to couple with a kingpin and configured to be received within the slots such that the housing and the kingpin are slidably coupled together; and
an actuator configured to operatively couple with the housing and configured to actuate to transition the trailer defense mechanism between a locked state and an unlocked state;
wherein, in the locked state, access to the kingpin is inhibited by the trailer defense mechanism such that the kingpin and a coupler of a vehicle are unable to engage with each other; and
wherein, in the unlocked state, access to the kingpin is permitted such that the kingpin and the coupler are not restricted by the trailer defense mechanism from engaging with each other.

2. The trailer defense system of claim 1, wherein the actuator is configured to selectively retract and extend to translate the housing in a first direction between a first position and a second position, thereby transitioning the trailer defense mechanism between the locked state and the unlocked state.

3. The trailer defense system of claim 2, wherein the trailer defense mechanism includes a base support including kingpin supports configured to engage with at least one of the engagement features or the kingpin to inhibit translation of the kingpin in the first direction.

4. The trailer defense system of claim 3, wherein the kingpin supports are spaced apart such that the kingpin and the engagement features are configured to be received therebetween.

5. The trailer defense system of claim 3, wherein the base support includes a base plate configured to couple to a bottom wall of the trailer, and wherein the kingpin supports extend in a vertical direction from the base plate.

6. The trailer defense system of claim 5, wherein the base plate defines a first opening, wherein the bottom wall defines a second opening, wherein the base plate is positioned such that the first opening is aligned with the second opening, and wherein the first opening and the second opening are configured to receive the kingpin and permit vertical movement of the kingpin therein.

7. The trailer defense system of claim 2, wherein the slots define a first portion proximate a top edge of the sidewalls, a second portion proximate a bottom edge of the sidewalls, and a third portion extending diagonally between the first portion and the second portion.

8. The trailer defense system of claim 7, wherein the first portion and the second portion extend in the first direction.

9. The trailer defense system of claim 8, wherein the first direction is a lateral direction or a longitudinal direction.

10. The trailer defense system of claim 1, wherein, during actuation of the actuator, the engagement features engage with the housing within the slots to vertically translate the kingpin between a retracted position and an extended position, thereby transitioning the trailer defense mechanism between the locked state and the unlocked state.

11. The trailer defense system of claim 10, wherein, in the retracted position, a bottom surface of the kingpin is flush with a bottom wall of the trailer.

12. The trailer defense system of claim 1, wherein the trailer defense mechanism is positioned, at least partially, within a cavity along a bottom wall of the trailer.

13. The trailer defense system of claim 1, further comprising a control system operatively coupled with the actuator and configured to control the actuator to selectively transition the trailer defense mechanism between the locked state and the unlocked state.

14. A method for installing a trailer defense mechanism onto a trailer including a bottom wall and a floor surface defining an interior volume, the method comprising:
provide a cavity within the floor surface of the interior volume;
providing the trailer defense mechanism including a base support, a kingpin, a housing, and an actuator;
coupling the base support to the bottom wall within the cavity;
slidably coupling the kingpin to the housing;
positioning the housing and the kingpin slidably coupled therewith within the cavity such that the base support engages with the kingpin; and
operatively coupling the actuator with the housing, the actuator configured to translate the housing in a first direction, thereby causing the kingpin to move in a vertical direction to transition the trailer defense mechanism between a locked state and an unlocked state.

15. The method of claim 14, wherein, in the locked state, access to the kingpin is inhibited by the trailer defense mechanism such that the kingpin and a coupler of a vehicle are unable to engage with each other, and wherein, in the unlocked state, access to the kingpin is permitted such that the kingpin and the coupler are not restricted by the trailer defense mechanism from engaging with each other.

16. The method of claim 14, wherein the housing includes sidewalls defining one or more slots, wherein the trailer defense mechanism includes one or more engagement features coupled with the kingpin and configured to be received within the slots such that the housing and the kingpin are slidably coupled together.

17. The method of claim 16, wherein, during actuation of the actuator, the engagement features engage with the housing within the slots to vertically translate the kingpin between a retracted position and an extended position, thereby transitioning the trailer defense mechanism between the locked state and the unlocked state.

18. The method of claim 14, wherein the actuator is configured to actuate to translate the housing in the first direction between a first position and a second position, thereby transitioning the trailer defense mechanism between the locked state and the unlocked state.

19. A trailer defense system comprising:
a trailer including a kingpin configured to engage with a coupler of a vehicle to facilitate coupling the vehicle to the trailer;
a trailer defense mechanism configured to (i) couple with or be integrated within the trailer, and (ii) selectively actuate between a locked state and an unlocked state; and
a control system configured to control actuation of the trailer defense mechanism to transition between the locked state and the unlocked state;
wherein, in the locked state, access to the kingpin is inhibited by the trailer defense mechanism such that the kingpin and the coupler are unable to engage with each other; and
wherein, in the unlocked state, access to the kingpin is permitted such that the kingpin and the coupler are not restricted by the trailer defense mechanism from engaging with each other.

20. The trailer defense system of claim 19, wherein the trailer defense mechanism includes:
a housing including sidewalls spaced apart from each other, the sidewalls defining one or more slots;
one or more engagement features coupled with the kingpin and configured to be received within the slots such that the housing and the kingpin are slidably coupled together;
an actuator operatively coupled with the housing and configured to selectively retract and extend to translate the housing in a first direction between a first position and a second position; and
a base support including kingpin supports configured to engage with at least one of the engagement features or the kingpin to inhibit translation of the kingpin in the first direction;
wherein, during actuation of the actuator and translation of the housing between the first position and the second position, the engagement features engage with the housing within the slots to translate the kingpin in a second direction between a retracted position and an extended position, thereby transitioning the trailer defense mechanism between the locked state and the unlocked state;
wherein the first direction is a lateral direction or a longitudinal direction; and
wherein the second direction is a vertical direction.
